(19) United States
(12) Patent Application Publication
(10) Pub. No.: US 2005/0182509 A1
(43) Pub. Date: Aug. 18, 2005

(54) Intelligent disturbance management

(75) Inventors: Sebastian Brandl, Bohmfeld (DE); Adalbert Stephan, Beilngries/Paulushofen (DE); Helmut Haunschild, Schamhaupten (DE)

Correspondence Address: DORITY & MANNING, P.A., POST OFFICE BOX 1449, GREENVILLE, SC, 29602-1449, US

(73) Assignee: RIETER INGOLSTADT SPINNEREIMASCHINENBAU AG

(21) Appl. No.: 10/969,770

(22) Filed: Oct. 20, 2004

(30) Foreign Application Priority Data
Oct. 22, 2003 (DE) 103 49 093.0

(51) Int. Cl. G06G 7/66

(52) U.S. Cl. 700/139

(57) ABSTRACT

Proposed is a procedure for the control of a service module for the maintenance of spinning stations and also a service module for the carrying out of this said maintenance. The procedure is carried out on a spinning machine, which can run at least one activity (A) at individual spinning stations, whereby this activity (A) consists, respectively, of at least one task (I-IV). In a case of a disturbance (4) in the course of the working of a task (I-IV), then the service module is immediately disconnected from automatic operation and is set in stillstand and subsequently, by the said service module itself, at least one procedure (a, b, c, d) for the correction of the said disturbance is carried out in order to complete the activity (A) which is to be carried out, or the service module is reset, into a fully operable state.

The present invention concerns a procedure for the control of a service module for the maintenance of spinning stations of a spinning machine, which said service module can at least apply one activity at any one of individual spinning stations, wherein this activity consists of at least a single task. In addition to this, the invention concerns a service module to be controlled by such a procedure.

In the case of modern spinning machines, which have a multiplicity of individual spinning stations, known service modules are installed in order that during normal operation, occurring maintenance applications can be taken care of. In this way, for one thing, personal attention for the operation of the said spinning machines can be reduced and at the same time the efficiency of the spinning machines can be increased. Certain activities consist of maintenance tasks in the scope of the invention, such as, for example, an exchange of full spools for empty spools, or the reintroduction of the thread and the thereto accompanying refastening of the said thread on the empty spool, or attending to a thread-break or cleaning a spin-rotor. In accord with the invention, it is also possible that additional other upkeep tasks can be taken over by the said service modules.

With the growing number of the operational duties to be carried out by the service modules, the complexity of design of the said apparatuses also increases. Experience has demonstrated, that the occurrence of disturbances in the carrying out of activities of service modules cannot be avoided. As a rule, a control apparatus can determine whether the required maintenance result has been achieved or not, but, in accord with the state of the technology, only after the correcting operation has been completed. If the said result has been correctly resolved, then the service module stands available for carrying out additional tasks. However, if the desired result has not been achieved, then a control apparatus conducts measures for the relief of the as yet unfinished operation. In accord with the present state of the technology, the known procedure is to have the corrective operation carried out repeatedly, in order to increase the probability, that this reoccurring action will eventually remove the instigating problem. In a case where the disturbance cannot possibly be corrected, this practice leads to an infinitely prolonged control-loop. In order to avoid this situation, the common solution is to define a maximum of non-successful trials and when the predetermined limit has been reached, the string of corrective trials is broken off, since the activity has brought about no positive results. The spinning station in question then remains in stillstand and the service module carries on its work at other spinning stations.

Along with this, other problems arise. For instance, it may frequently come to a point wherein foreign erroneous operations are introduced into the service module during the working-up of specific individual tasks of an activity. The basis for such a situation can be, for example, deviations in the voltage or in the compressed air supply of a spinning machine, which subsequently leads to an effect, wherein, for example, pick-up arms do not place themselves in their specified positions of designed extension. Under such circumstances, the service module is shutdown by the control apparatus even during its performance of a maintenance operation. This shutdown is done, as a rule, by the instantaneous disconnection of the automatic operation and the stopping of the service module while it is in action. One principal purpose of the shutdown, for example, is to avoid collisions. Following the above described shutdown, both the service module as well as the spinning station are put out of service. This is disadvantageous, in that the spinning station in question cannot produce during this time of stillstand and the service module cannot continue its attention to necessary occurrences at other spinning stations. The end result of the said shutdown of the described kind at a spinning station, caused by the now absent attention of the service module, is a production loss at other spinning stations. This situation can be changed only by means of manual intervention by an operator, who places the service module once more in a functioning mode.

On this account, it is the purpose of the invention, to create a procedure and a service module, with which the automatic execution of maintenance of spinning machines is improved in efficiency and reliability.

In order to achieve these purposes, the procedure mentioned in the introductory passages is characterized, in that in the case of a disturbance in the corrective operation of a service module, the said module is to be immediately converted from its automatic operational condition into a stillstand, and subsequently, by the self-action of the service module, at least one initial method would be exercised for the correction of the existing disturbance, in order to put an end to the problem which is currently taking place, or alternately, the service module could be again converted into operable condition.

The invented procedure assures that the service module, after the shutting off of the automatic operation due to an operational disturbance, does not remain motionless and inoperative in its position. Experience has indicated, that frequently errors which happen sporadically, lead to the shutdown of service modules. Such errors can, for example, occur because of short time variations in the voltage supply. Should there be a drop in voltage, while the service module is performing a maintenance task, then this said drop can possibly lead to a situation in which an electrically driven positioning motion cannot be completely carried out. The control apparatus would, in this case, detect the non-completion of a desired assigned task and disconnect the service module from electrical power, even before the said assigned task has been completed. However, should at this point, the control apparatus, as the invention would propose, start a renewed endeavor to complete the task, as a rule, this would be successfully performed, since sporadic disturbances, such as the described variation in voltage, do not continually endure and the said task can, without hindrance, be brought to a successful end. Finally, as a result of this invented method, a predominate part of the shutdowns caused by disturbances the service module can correct by its own action. The operator, on this account, spends very much less time in placing the disconnected service module back in operation.

Simultaneously, during the stillstand period which has been eliminated by the invention, the service module can continue its maintenance operations at other spinning stations, which substantially increases its efficiency. Furthermore, the automatic standard operational mode of the service module is increased by an automatic special functioning mode. This comes about since the said special functioning mode, after the standard operation mode has been interrupted or shutdown, begins to take steps toward the goal of putting the service module back in action. For the execution of this task, one or more methods of operation are available for the said special functioning mode.

One development of the invention proposes that the service module be first operated in its basic intended manner. This has the advantage, that the service module, independently of the selected method, and without consideration as to whether or not the task has been properly completed, stands ready for carrying out further tasks and activities, both at the actual spinning station wherein it is located or at other spinning stations of the spinning machine. In addition to this, in accord with the invented procedure, the assurance can be safely taken in the basic state, that all component elements (hereinafter “aggregates”) of a service module would be found in a specified and known starting condition.

Advantageously, where one manner of procedure is concerned, such aggregates of the service module can be run in their basic state with assurance of avoiding collisions. Service modules are complex apparatuses, which possess a plurality of movable aggregates. Thereby a situation exists, that the movement paths of individual aggregate components intersect. This means, that under certain operational conditions of the service module, internal collisions between such components could occur. However, such said operational conditions, in accord with the invention, are excluded. The control apparatus, with this possibility in mind, is so programmed that collision conditions are barred and instead of the described questionable operation, a alternate and collision-free series of program steps is chosen for the movable functioning of the said aggregate.

A particularly favorable situation is evident, in that, in the course of one procedure, the activation as it originates from the basic state is carried out anew. This means that the activation can be begun out of a defined basic state in a completely renewed manner. This renewal procedure is especially designed to eliminate concurrent disturbances, which occur as consequential faults arising from poorly executed previous tasks.

Besides the above, it is of advantage if in one method of operation, an activity concerned with correcting a problematic task be renewed. In the case of certain occurring disturbances, it suffices to do no more than repeat the faulty task. To carry out this simple repetition is particularly time saving since the service module is not required to return to its first basic state. For example, in this case, the extending action of a gripping arm is now described. If a first endeavor of, for example, directing the motion of a compressed air driven gripping arm into an extended position fails, then it is to advantage, to first repeat the task of moving the said gripping arm. This saves that time which the service module would require to revert to its basic state and subsequently make the said repetition from that programmed position.

It is additionally favorable, if with one procedure, the activity of a successfully accomplished task can be renewed, particularly where this said task prior to an currently scheduled corrective task. Depending upon the characteristics of the corrective measure to be taken, it is of advantage to start anew the carrying out of an activity, for example this being the activity of a task which occurred one or two steps back in the automatic succession of service module activities. If this prior task, which was successfully accomplished, consisted of cleaning a rotor by means of a scraper or by compressed air, the result will be that the renewed cleaning operation improves the already accomplished cleaning. Where the spinning operation is concerned with natural fibers, besides these fibers, frequently undesirable foreign materials are impacted in the fiber band, such materials could be, for example, sand or vegetable residuals. Such foreign materials are difficult to remove in their entirety, on which account, a second cleaning procedure carried out in a short interval is almost always of advantage.

On this account, in a development of the invention, the proposal is made, that in one procedure, the activity of a first task, which follows a task which has been subjected to a disturbance, be repeated. This has the advantage, that a task can then be carried out, particularly when a disturbance occurs during a corrective action. This said disturbance need not be necessary nor optional for the proper accomplishment of the task. The example of this situation can be the above mentioned cleaning of a rotor. If, for example, upon a change of the yarn spool a demand is made during rotor cleaning, then it is possible to decline to perform this yarn spool change and the original cleaning activity would then be carried out to a successful end.

Favorable in this case, would be to provide an upper limit, which would offer the maximum number of omissions to a specific activity. There are, however, some tasks that cannot be repeated. Among these, for example, would be the exchange of a full spool for an empty spool. The task of the spool exchange cannot be repeated, since then a redundant empty spool would be again substituted for an already exchanged empty spool. In this case the control apparatus could more efficiently employ one of the previously described procedures and demand a start on a subsequent task which has signaled a disturbance.

Further, it is advantageous, if different methods of operation are combined with one another and executed in series fashion, one after the other. If the control apparatus determines that a completed repetition of a corrective task, following a prior accomplished task, did not set aside a disturbance, then the control apparatus can provide that the entire service module system be set back to its basic state and the necessary corrective action will begin again from this fundamental standpoint. As a matter of principle, it is possible that all conceivable procedures can be combined with one another. In doing this, however, it is preferable that certain combinations of procedure be avoided. For example, this would be illustrated in an afore said exchange of a yarn spool, whereby in a renewed execution of the activity from the beginning on, the spool becomes redundantly replaced.

It is of greater advantage in such a case to proceed at once from the spool exchange task to the next demanded task for the said renewal of action. Fundamentally, however, it is valid for all procedures, that a combination of various such procedures serves to increase the possibility of successfully correcting disturbing tasks.

Shown to be likewise of advantage, is that for any of the chosen procedures a maximum number of trials toward successful results is presupposed, after the attainment of which threshold number, the operation for the specific correction by the service module is cancelled and the service module is returned to its basic state. Under certain circumstances, it is advantageous, to limit the repeated trials of a corrective measure. This is, first, the case when it has been determined, that the task, under any conditions, cannot be accomplished. For example, this is the case, when a service module is confronted with an auxiliary yarn supply. In this situation, there is no possibility to assure that a successful spool exchange with concomitant reapplication of the thread thereon can be carried out successfully. Each additional attempt to carry out this activity would be a waste of time. The limitation of the number of trials is advantageous in order to avoid endless control looping, wherein the service module repeatedly and undesirably attempts to fulfill a given task or activity.

Related hereto, it is entirely advantageous, when selectively, different procedures are assigned limitation numbers representing different threshold values. In this way, the control of the service module can be matched to the application, wherein, for example, a determination might be made, to the effect that after a second attempt, it is no longer of value to carry on, that is to say, further action is unnecessary and would be without satisfactory result. In contrast thereto, other tasks can be appointed to have a higher number of allowed trials, if the indications are clear that, within an allowable time-span, the possibility of a successful corrective action is favorable.

Likewise of advantage, it has been shown, that upon the occurrence of a disturbance, an alarm should be emitted. In this way, an operator of the service modules is made aware of an undesirable situation on the spinning machine.

Advantageously, this said alarm would be stored in a computer error memory. This stored alarm, at a later, convenient time, could be retrieved.

In an advantageous manner, the retrieval is done in order to make an evaluation, particularly when one or more alarm signals are to be found in the said memory. Occurring disturbances can be frequently recognized in this manner, and the operator can, with directed intent, take counter measures on such components of the service module as contribute to said disturbances.

In a particularly advantageous embodiment of the invention, upon repeated occurrences of one kind of disturbance at a plurality of spinning stations, the disturbance can be communicated with its predetermined probability to a service module and upon repeated occurrences, this one kind of a disturbance with its predetermined probability can be assigned to a spinning station. By means of this particular form of evaluation, it is possible that the source of the cause for a disturbance itself can be targeted.

For the operation of the machine, it is of special advantage, if the result of the evaluation is displayed. One evaluation statement can be made on a monitor screen or by audible means. The operator and/or the control apparatus can collect data by means of possible disturbance sources of a spinning machine, which enables timely and preventive maintenance on the machine.

Along with this, it is particularly of advantage, if such procedures, activities and/or tasks, which, in a very highly probable manner, induce a disturbance of the service module, are blocked from further effect by the control apparatus. For example, should it so happen, that a particular procedure can only be successively carried out in one of ten cases, then the control apparatus can be so programmed, that this procedure cannot be further employed, up to the moment of use of the concerned aggregate of the service module or of the concerned spinning station, in accord with the assignment of the cause of the disturbance.

Advantageously the tasks are preliminarily classified as repeatable or non-repeatable, that is to say, classified into obligatory or optional tasks. This possesses the advantage, that for example, with the programmable, technical design of the control apparatus, this classification, is especially easy to incorporate therein. Unnecessary executions of tasks, for example, the cited double change of a spool which is immediately successively carried out or the bypassing of very important obligatory tasks, can be avoided by the use of the invented procedure.

In order to be assured of a safe and reliable operation, it is of special advantage, if the service module is placed in a “park” position in a case of complete functional failure or the said module tends toward understepping a specified minimal operation. If a service module should have no function it could carry out or if the remaining functions are no longer of value, it better that the said service module be brought into the park position. Other service vehicles can then be run in the place of the faulty service vehicle, without the danger that a collision or loss of time due to waiting or avoidance movements may occur. For this purpose, an out-of-service placement in a separate park position is possible without blocking the travel path for other service modules.

It is entirely advantageous, in this matter, if a signal is given following the shunting into a park position. If a service module is standing on a park position, the operator is made aware of this by the said signal and the operator can begin the necessary repair work. For the improvement of monitoring the state of the machines by an operator, especially in cases of extensive spinning machine installations, it is well to provide this said signal, or a complementary wide ranging signal which could be a light, a flasher, or an acoustic alarm. An electric signal is also possible, for instance at a central machine control panel or at a spinner works direction station. Such signals should indicate the location of the difficulties.

The invention also concerns a service module having a control apparatus to regulate the maintenance of spinning stations on a spinning machine. This device would carry out at least one action at any individual spinning station, wherein the said action consists of at least one task.

The invented service module is therein characterized, in that a control apparatus monitors the execution of assigned tasks and, further, upon an occurrence of a disturbance during a task, immediately shuts down the automatic operation and stops the service module from further action. Subsequently at least one selected procedure for the correction of the present disturbance is carried out to successfully complete the assigned task or, as an alternate, to place the service module in an operation-ready state. Thus stillstand delay of the service module can thus be avoided and as a result a drop in production time due to faulty maintenance is reduced. Also, the conversion to the invented practice is especially simple. The control apparatus used on the service modules operate, as a rule, in accord with predetermined programs. Thus the invention is particularly easy to implement into conventional service modules. To effect the said conversion, it is simply necessary to conform to the specified programming.

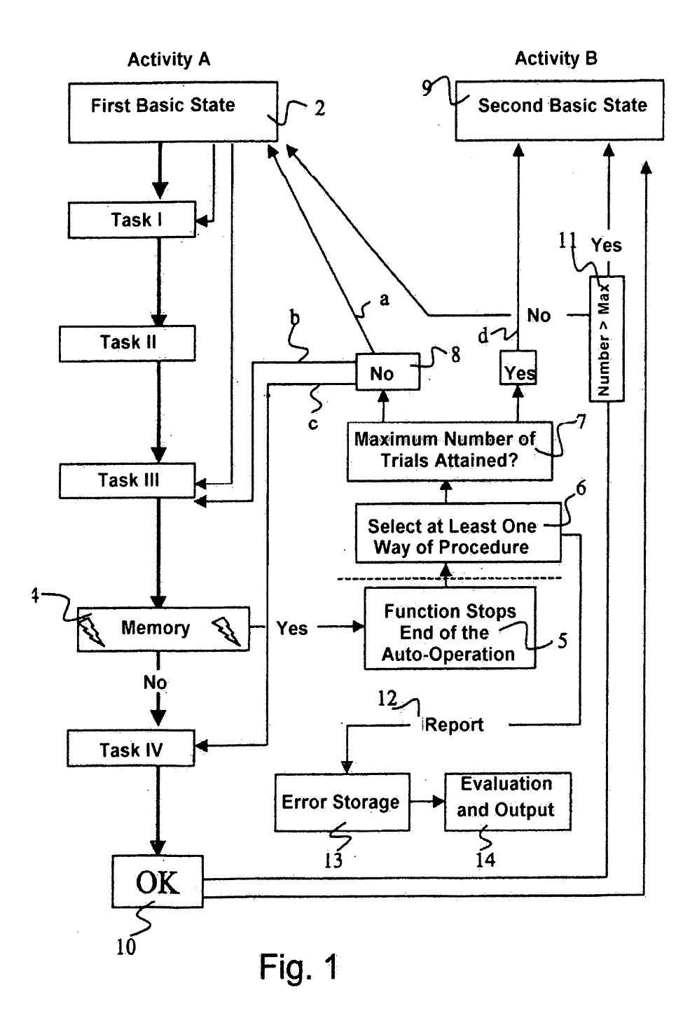

Additional preferred embodiments of the service module are to be found in the subordinate claims. Besides the already mentioned advantages of the invention, additional favorable features in connection with the following embodiment example are more closely described with the aid of the drawing. There is shown in FIGURE 1 (of 1).

FIGURE 1 a schematic program diagram of an activity responsive to a disturbing activity in accord with an invented procedure.

In FIGURE 1 is to be seen a schematic programming plan in accord with the invention. An apparatus for the carrying out of service procedures on a spinning machine, such as, for example, a service module or a maintenance robot, should be capable of executing a specific activity A on the spinning machine. This assigned activity A is initiated at a first basic state 2. Thereafter, successive tasks are to be accomplished in the shown order. These tasks as shown are designated as the four tasks I-IV. In the programming example illustrated, a disturbance 4 interposes itself between the task III and the task IV. The disturbance 4, for example, could be that a gripping arm of the service module is obstructed in its travel to a specified end position. A control apparatus located on the service module is made aware of such a disturbance, for instance, because of a lack of a signal from the end position limit switch.

In such a case, the control apparatus immediately shuts down the automatic operation of Step 5, and the service module becomes inoperative. In a different manner than has been indicated in procedures up to this time, in accord with the invention, the control apparatus, in accord with the present invention, continues to perform the assigned activity. This is made possible, in that in Step 6, immediately, operations continue in at least one of the possible procedures, designated as a, b, c, d. Consecutively, an examination is made in Step 7 to determine how often the selected said methods a, b, c, d have already been tried in connection with the present disturbance 4. If this is not the case, then, for example, an electronic or mechanical counting device is set from the original 0 to the value 1. Simultaneously the test is carried out as to whether or not a specified maximum number of trials have been made by the said selected procedure.

Advantageously, the value of all the chosen procedures is equal to, or greater than one, so that, if in a first-time execution of a procedure, this criterion has not been fulfilled, then at least an initial trial can be made. In the last described case, the control apparatus proceeds to Step 8, which launches the procedural methods a, b, c, d. Insofar as the maximal number of trials of all the said procedures is attained, that is to say, when the control apparatus has caused the maximum number of trials to be carried out, the control apparatus disconnects the activity A and has the service module, in accord with the procedure d, revert to a Second Basic State 9, whereupon, the said service module stands ready for an activity B.

If, however, the maximum number of trials in Step 7 has not yet been reached, then the service module in Step 7 advances to Step 8 in order to carry out the at least one of the selected procedure a, b, and c. Emanating from Step 8, besides the procedure d, which provides for a general shutdown, are available essentially three different procedures, namely, a, b, and c. Procedure a provides, that the service module reverts into its First Basic State 2. This is done giving consideration to and avoiding possible collisions of the individual aggregates of the service module. Starting at the First Basic State 2, it is possible that the service module can accomplish the assigned activity A, and then, in accord with the activity to be done, carry out one of the tasks I-IV. Illustrated in the present overall program plan, are procedure paths from the First Basic State to a renewed action of the task I, or, alternative to this, a selection of the task III. Consideration, however, can also be given to each other task, in this case this being the choice of tasks II and IV, which tasks can serve as initiation points for a repeated operation.

The selected procedure b provides, that the service module principally repeats the last operated task III, which is combined with the disturbance 4. In the case of this procedure b, it is necessary that the service module need not originally revert to its First Basic State 2. This saves time and in many cases is already a sufficient procedure for the correction of the disturbance.

Finally. the procedure c provides, that the task III, which has been subjected to a disturbance, can be simply omitted, and the carrying out of the activity A started anew on the task IV. This is possible, for example, if the disturbance present at the task 3 is optional. Such an optional task is, for example, box-cleaning, which actually is done upon the attaching of a yarn, although, for the successful finishing of the action as a whole, this is not totally necessary. Experience in the practice has shown further, that with the increasing number of trials for the correction of disturbances and with an increasing number of selected procedures, the probability of the correction of a disturbance 4 is significantly improved. In the normal succession of actions, it is advantageous, if a plurality of procedures are combined with one another. Consideration can also be given, in a case of a of a disturbance 4 of the task III, to first select the procedure b and the carry out the said task III once again. If the disturbance 4 still remains, then the control apparatus is to run through the steps designated as 5, 6, 7 and 8 up to the end of the maximum threshold number of trials, which number is assigned to the procedure b. Subsequent to the procedure b it is possible, as an example, that the procedure a can be carried out, which runs the service module into the First Basic State 2 and diverts the operation of the activity A to be run as the task I. Insofar as even here the disturbance 4 has not been corrected, then, if following a renewed processing through the steps 5, 6, 7 and 8, possibly to the limit of the maximum allowed trials, then the procedure c is carried out in order to finally obtain positive results. In the case of selecting the procedures a, b, c, d in step 6, consideration must be given to whether the tasks I-IV for the current activity A are obligatory or optional, and whether the tasks I-IV are such that can be run another time. With this in mind, it is not advantageous upon the change of a full yarn spool to extract this out of the spinning station and set an empty shell in its place, and then, in case of an occurring disturbance, to repeat this action. For the optimization of the successive control the operating person must recognize, that there exists a technologically programmed classification of optional tasks vs obligatory tasks on the one hand, and on the other hand, a classification for non-repeatable tasks in order to determine and select the procedures a, b, c, d in step 6. If now, the selected procedures a, b, and c are run to the desired correction of the disturbance, then the service module progresses, with an O.K., to the designated step 10. At this point, as also previously, a check is made by the control apparatus, as to the whether the desired activity A is satisfactorily completed. If this is the situation, then the service module moves on into the Second Basic State 9. If this is not the case, than in step 11, the number of repeated trials is determined and examined, as to whether or not the maximum number had been attained or not. In the last named case, i.e. “not”, the working at the Activity A is broken off and the Second Basic State 9 is approached. If the maximal number, nevertheless has not be attained, then the control apparatus again initiates the activity A. For this purpose, the control apparatus runs the service module into the First Basic State 2, and the cycle begins all over again. Consideration can also be given at this point to allowing the service module to move directly from one of the tasks I-IV.

As an augment to the described and improved consecutive control in the case of activities related to disturbances, the invented procedure provides, in addition to a procedure a, b, c and d in Step 6, also the issuing of an announcement 12, which is first input in the error storage 13. This error storage 13 serves for the documentation of occurring disturbances 4. An evaluation and information apparatus affixed to the said error storage 13 can be purposefully used in order to make available the informational data which have been input, as said, into the error storage 13. In this way, the operator can be informed of the details, if a certain type of disturbance occurs frequently. It is also possible to indicate a disturbance to the operator, even when this has been already automatically corrected. If. for example, a certain type of disturbance occurs at different spinning stations, then, the fault may lie, with high probability, in the d service module itself. In a converse case, that is, a certain type of disturbance repeats itself at only one particular spinning station, then, it is again highly probable, that the assumption can be made, that the cause of the fault is to found in the spinning station. By the use of the invented evaluation, it is possible, first, to more easily determine the cause of the disturbance, and second, an improved correction-applicability of the service module can be achieved, in that the service module, for example, may be blocked in a certain function, but other functions, which operate fault-free, can still remain in normal service.

The present invention is not limited to the here presented embodiment examples. Many more diverse versions of the invention are possible within the framework of the patent claims. In this way, it is possible instead of the described evaluation methods, to employ numerous other fault-judging procedures in accord with the present invention. By means of the invented procedure and the invented service module, it is additionally possible, to significantly reduce the frequency of disturbing shutdowns of the service modules, which entail manual intervention by the operating personnel. Furthermore, the availability of the service modules is clearly increased. Developments can be foreseen, in that service modules can, within specified rules, transfer, or apportion, assignments directed to them to other service modules. This can occur during the failure of one or more functions or if functions of very low degrees of efficiency are to be exercised, such as, for instance, poor effects of thread replacements.

1. A procedure for the control of a service module for the maintenance of spinning stations of a spinning machine, which can at least carry out an activity (A) at the individual spinning stations, whereby this activity consists of at least one task (I-IV), therein characterized in that in the case of a disturbance (4) in the processing of a task (I-IV) the said service module is initially converted to a stillstand condition and subsequently, by means of the same service module, at least one procedure (a, b, c, d) for the correction of the said disturbance (4) is executed, in order that the activity (A) to be carried out is successfully completed or the service module is again placed in a fully functional state.

2. A procedure in accord with the foregoing claim, therein characterized, in that the service module is first directed into its First Basic State (2).

3. A procedure in accord with one of the foregoing claims, therein characterized, in that in the case of one procedure (a. b, c, d) the elements of the service module in order to avoid collisions are directed into the First Basic State (2).

4. A procedure in accord with one of the foregoing claims, therein characterized, in that in the case of one procedure (a, b, c, d) the activity (A) can initiate its renewed operation from the First Basic State (2).

5. A procedure in accord with one of the foregoing claims, therein characterized, in that according to one procedure, (a, b, c, d) the activity (A) can be renewed from the tasks (I-IV) which are subjected to disturbance.

6. A procedure in accord with one of the foregoing claims, therein characterized, in that in the case of one procedure (a, b, c, d) the activity (A) can be renewed from a successfully completed task (I-IV), which lies before a task (I-IV), which latter task is subjected to disturbance.

7. A procedure in accord with one of the foregoing claims, therein characterized, in that in the case of one procedure (a, b, c, d), the activity (A) can be renewed from a task (I-IV) which follows a task (I-IV) which is subjected to disturbance.

8. A procedure in accord with one of the foregoing claims, therein characterized, in that the different procedures (a, b, c, d) can be combined with one another and carried out in successive operations.

9. A procedure in accord with one of the foregoing claims, therein characterized, in that a maximum number of trials for a successful completion for any of the selected procedures (a, b, c, d) is specified, and following the attainment of the said number, the execution of the activity (A) by the service module is broken off and the said service module is placed in its Second Basic State (9).

10. A procedure in accord with one of the foregoing claims, therein characterized, in that optionally, the different procedures (a, b, c, d) can be respectively be assigned different maximum numbers of trials.

11. A procedure in accord with one of the foregoing claims, therein characterized, in that upon the occurrence of a disturbance (4), an announcement (12) thereof is emitted.

12. A procedure in accord with one of the foregoing claims, therein characterized, in that this said announcement (12) is input into an Error Storage (13).

13. A procedure in accord with one of the foregoing claims, therein characterized, in that an evaluation (14) will be made, when one or more announcements (12) are to be found in the Error Storage (13).

14. A procedure in accord with one of the foregoing claims, therein characterized,
in that upon the repeated occurrence of one kind of fault at a plurality of spinning stations registered by one service module, the said fault, with its predetermined probability, is assigned to the concerned service module and
in that upon repeated occurrence of one kind of fault at an individual spinning station, the fault, with its predetermined probability, is assigned to the said spinning station.

15. A procedure in accord with one of the foregoing claims, therein characterized, in that the result of the evaluation (14) is displayed.

16. A procedure in accord with one of the foregoing claims, therein characterized, in that such procedures (a, b, c, d), activities (A) and/or tasks (I-IV), which, with high probability can bring about a disturbance (4) of the service module, are not issued by the control apparatus.

17. A procedure in accord with one of the foregoing claims, therein characterized, in that the tasks (I-IV) are classified as being repeatable or non-repeatable.

18. A procedure in accord with one of the foregoing claims, therein characterized, in that the tasks (I-IV) are classified as obligatory or optional.

19. A procedure in accord with one of the foregoing claims, therein characterized, in that the service module is placed in a park position in a case of complete functional failure or by incomplete attainment of a minimal functionality.

20. A procedure in accord with one of the foregoing claims, therein characterized, in that following the movement of a service module to a park position, or immediately therewith, a signal is emitted.

21. A service module with a control apparatus for the maintenance of spinning stations in a spinning machine, which at least carries out an activity (A) at the individual spinning stations, whereby this activity (A) consists of respectively a task (I-IV), therein characterized, in that the control apparatus monitors the execution of the tasks (I-IV) and, upon the appearance of a disturbance (4) during the execution of a task (I-IV), immediately disconnects the automatic operation and places the service module in a stillstand state (5) and subsequently carries out at least one selected procedure (a, b, c, d) for the correction of the said disturbance (4), in order to successfully complete the activity (A) which is to be carried out, or to place, again, the service module in an operation-ready state.

22. A service module in accord with the foregoing claim, therein characterized, in that provision has been made in regard to a procedure (a, b, c, d) to run the service module immediately into its First Basic State (2) and thereafter undertake a new start of the activity (A).

23. A service module in accord with one of the foregoing claims, therein characterized, in that, unallowable operational conditions are defined for the service module and these said unallowable operational conditions are blocked in the functioning of the procedure (a, b, c, d).

24. A service module in accord with one of the foregoing claims, therein characterized, in that the execution of the activity (A) is started anew from the First Basic State (2).

25. A service module in accord with one of the foregoing claims, therein characterized, in that the execution of the activity (A) is started anew, when a task (I-IV) is subjected to a disturbance.

26. A service module in accord with one of the foregoing claims, therein characterized, in that the execution of the activity (A) is started anew by one of the tasks (I-IV) which lies before one of the tasks (I-IV) which is subjected to disturbance.

27. A service module in accord with one of the foregoing claims, therein characterized, in that the execution of the activity (A) is started anew by one of the tasks (I-IV) which lies after one of the tasks (I-IV) which is subjected to disturbance.

28. A service module in accord with one of the foregoing claims, therein characterized, in that the control apparatus combines at least two of the procedures (a, b, c, d).

29. A service module in accord with one of the foregoing claims, therein characterized, in that a counting mechanism (7) is provided, which determines the number of the carried out trials for each procedure (a, b, c, d), and the control apparatus ends the execution of the selected procedure (a, b, c, d) after the reaching of a specified maximum number of trials and directs the service vehicle to its Second Basic State (9).

30. A service module in accord with one of the foregoing claims, therein characterized, in that the counting mechanism (7), provides different maximum numbers of trials for the different procedures (a, b, c, d).

31. A service module in accord with one of the foregoing claims, therein characterized, in that the control apparatus, upon the occurrence of a disturbance (4) generates an announcement (12).

32. A service module in accord with one of the foregoing claims, therein characterized, in that the control apparatus possesses an Error Storage (13) and saves therein announcements (12) in regard to disturbances (4).

33. A service module in accord with one of the foregoing claims, therein characterized, in that the control apparatus undertakes an evaluation (14) of the content of the Error Storage (14), when one or more announcements (12) can be found in the said Error Storage (14).

34. A service module in accord with one of the foregoing claims, therein characterized,
in that the Error Storage 13, upon repeated occurrences of one type of disturbance at a plurality of spinning stations, directs that said disturbance, along with its predetermined probability to the service module and
in that upon repeated occurrences of one type of disturbance at an individual spinning station, assigns the said occurrence, with its specified probability, to the said spinning station.

35. A service module in accord with one of the foregoing claims, therein characterized, in that the control apparatus issues the results of the evaluation by means of an audio or visible communication.

36. A service module in accord with one of the foregoing claims, therein characterized, in that the tasks (I-IV) are classified as repeatable or non-repeatable tasks (I-IV).

37. A service module in accord with one of the foregoing claims, therein characterized, in that the tasks (I-IV) are preliminarily apportioned as obligatory or optional tasks (I-IV).

38. A service module in accord with one of the foregoing claims, therein characterized, in that the tasks (I-IV) are preliminarily classified as being repeatable or non-repeatable tasks (I-IV).

39. A service module in accord with one of the foregoing claims, therein characterized, in that the control apparatus possesses a means for monitoring the functional reliability of the service module, as well as similarly monitoring drive and motion means which lead to a park position.

40. A procedure in accord with one of the foregoing claims, therein characterized, in that the signal emitting means is provided, which, upon the attainment of the park position, emits a signal.
